(19) United States
(12) Patent Application Publication
(10) Pub. No.: US 2008/0182626 A1
(43) Pub. Date: Jul. 31, 2008

(54) COMPUTER PRODUCT, PROCESS EXECUTION DEVICE, AND METHOD OF PROCESS EXECUTING

(75) Inventor: Hiromi WATANABE, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/021,435

(22) Filed: Jan. 29, 2008

(30) Foreign Application Priority Data
Jan. 29, 2007 (JP) 2007-18051

(51) Int. Cl. H04B 1/38

(52) U.S. Cl. 455/564

(57) ABSTRACT

A computer-readable recording medium which stores therein a computer program that causes a computer to implement a method for executing processing depending on the areas directed by a user by means of pressing or touching in an input key comprising a plurality of areas, the computer program causes the computer to execute a storing function in which a correspondence relation of the plurality of areas and the content of processing which the respective areas correspond to the same content of processing in each area group is stored; and executing a selected content of processing which corresponds to the directed area by a user in accordance with the stored correspondence relation.

### CROSS REFERENCE TO RELATED APPLICATIONS

The disclosure of Japanese Patent Application No. JP 2007-018051 filed on Jan. 29, 2007 including the specification, drawings abstract is incorporated herein by reference in its entirety.

### BACKGROUND OF THE INVENTION

1. Technical Field

The present invention relates to a technology for accepts direction from a user by means of pressing or touching in an input key comprising a plurality of areas and executes the contents of processing in accordance with the directed area.

2. Description of the Related Art

A device, such as mobile terminal device, electronic device, or remote-controller that operates these devices remotely, has an input key comprising a plurality of areas so as to accept direction from a user by means of pressing or touching. In the input key, one processing has been corresponded to one area. For example, when a button with a number is pressed in the input key, processing of receiving this number as a part of the outgoing call number is executed.

On the other hand, the technology that a plurality of processing is corresponded to one area in the input key is known as well. For example, in the input key of the mobile terminal device, when “power” button is pressed within a predetermined time, processing of displaying an initial screen is executed, and when the button is pressed longer than the predetermined time, processing of turning off the power is executed.

There is Japanese Laid-Open Patent Publication No. 2006-148316 as a technology that relates to the input key comprising a plurality of areas. In the mobile terminal device which is able to execute a plurality of application programs at the same time, Japanese Laid-Open Patent Publication No. 2006-148316 discloses the technology that enables to start and switch application program by a little operation frequency for the input key. Specifically, the mobile terminal device stores the correspondence relation of the button and the application program in advance, so that the application can be started with direction from a user by means of pressing the button. The mobile terminal device stands by until the button is pressed by a user, displaying the correspondence relation. When the button is pressed, the mobile terminal device activates the corresponding application program, or switches the application program to an applicable application program.

There is Japanese Laid-Open Patent Publication No. 2002-315080 as a technology that relates to the input key provided with a light source. Japanese Laid-Open Patent Publication No. 2002-315080 discloses the technology that easily indicates which area can operate which electronic device, to a user by providing the light source in the input key comprising a plurality of areas of the remote-controller that can operate several kinds of electronic device. Specifically, the remote-controller stands by until the operating button is pressed by a user, emitting light of the same color for the mode switching buttons used to switch the electronic device targeted to be operated, and the operating buttons used to operate the electronic device currently selected by the mode switching button.

However, there is a problem in that the operability to a user is lacking in the technology described above. Specifically, a problem of poor operability to a user occurs when a user has to take aim to one intended area to prevent from pressing the neighboring area in the input key of the mobile terminal device. Recently, as the body of the device has become smaller, every single area in the input key of the mobile terminal device has become smaller. For example, the above-described problem is serious for senior citizens etc. who generally are not capable of such detailed work.

### SUMMARY

It is an object of the present invention to at least partially solve the problem in the conventional technology.

According to an aspect of an embodiment, a computer-readable recording medium stores therein a computer program that causes a computer to implement a method for executing processing depending on the areas directed by a user by means of pressing or touching in the input key comprising a plurality of areas, the computer program causing the computer to execute: storing a correspondence relation of a plurality of the areas and the content of processing that the respective areas are corresponded to the same content of processing in each area group comprising a plurality of areas; and executing a selected content of processing which is corresponded to the directed area by a user in accordance with the correspondence relation is store.

According to another aspect of the embodiment, a process execution device that that accepts direction from a user by means of pressing or touching in the input key comprising a plurality of areas and executes processing depending on the directed areas, the process execution device comprising: a memory unit that stores the correspondence relation of a plurality of the areas and the content of processing that the respective areas are corresponded to the same content of processing in each area group comprising a plurality of areas; and a process execution unit that executes a selected content of processing and selects the content of processing corresponding to the areas directed by the user in accordance with the correspondence relation which is stored by said memory unit.

According to still another aspect of the embodiment, a method of process executing that accepts direction from a user by means of pressing or touching in the input key comprising a plurality of areas and executes depending on the directed areas, the method comprising: storing a correspondence relation of a plurality of the areas and the content of processing that the respective areas are corresponded to the same content of processing in each area group comprising a plurality of areas; and executing a selected content of processing which is corresponded to the directed area by a user in accordance with the correspondence relation is store.

The above and other objects, features, advantages, and technical and industrial significance of this embodiment will be better understood by reading the following detailed description of presently preferred embodiments, when considered in connection with the accompanying drawings.

### BRIEF DESCRIPTION OF THE DRAWINGS

FIG. 1 is a diagram illustrating the overview and feature of the mobile terminal device that relates to the first embodiment.

FIG. 2 is a block diagram of the configuration of the mobile terminal device that relates to the first embodiment.

FIG. 3 is a diagram illustrating one example of information that is stored by the correspondence relation memory unit.

FIG. 4 is a diagram illustrating the overview of the mobile terminal device that relates to the first embodiment.

FIG. 5 is a flow chart of the flow of processing execution by the mobile terminal device.

FIG. 6 is a diagram of the mobile terminal device that relates to the second embodiment.

FIG. 7 is a block diagram of the configuration of the mobile terminal device that relates to the second embodiment.

FIG. 8 is a diagram illustrating one example of the information that is stored by the correspondence relation memory unit.

FIG. 9 is a diagram illustrating one example of the screen displayed by the output unit.

FIG. 10 is a flow chart of the flow of processing execution by the mobile terminal device.

FIG. 11 is a flow chart of the flow of assigning processing by the mobile terminal device.

FIG. 12 is a diagram illustrating the determination of grouping.

### DETAILED DESCRIPTION OF THE PREFERRED EMBODIMENTS

In the following embodiment, for example, the case where the process execution program is applied to the mobile terminal device i.e., a cellular phone is explained, but the embodiment is not limited to this case. In other embodiment, the process execution program is applicable to a PHS (Personal Handy-phone System), a PDA (Personal Digital Assistant), a personal computer, and a remote-controller, and the like. In other words, a device is also applicable if it at least has an input key comprising a plurality of area as typified by a plurality of operating buttons, operating keys or touch panels, and when it accepts direction from a user by means of pressing or touching to execute processing depending on the directed areas.

### The First Embodiment

Referring to the accompanying drawing below, the overview and feature of the mobile terminal device that relate to the first embodiment, the configuration and processing flow of the mobile terminal device that relates to the first embodiment and the effect of the first embodiment are explained, respectively, and then other embodiments are explained sequentially.

### Overview and Feature of Mobile Terminal Device that Relates to the First Embodiment

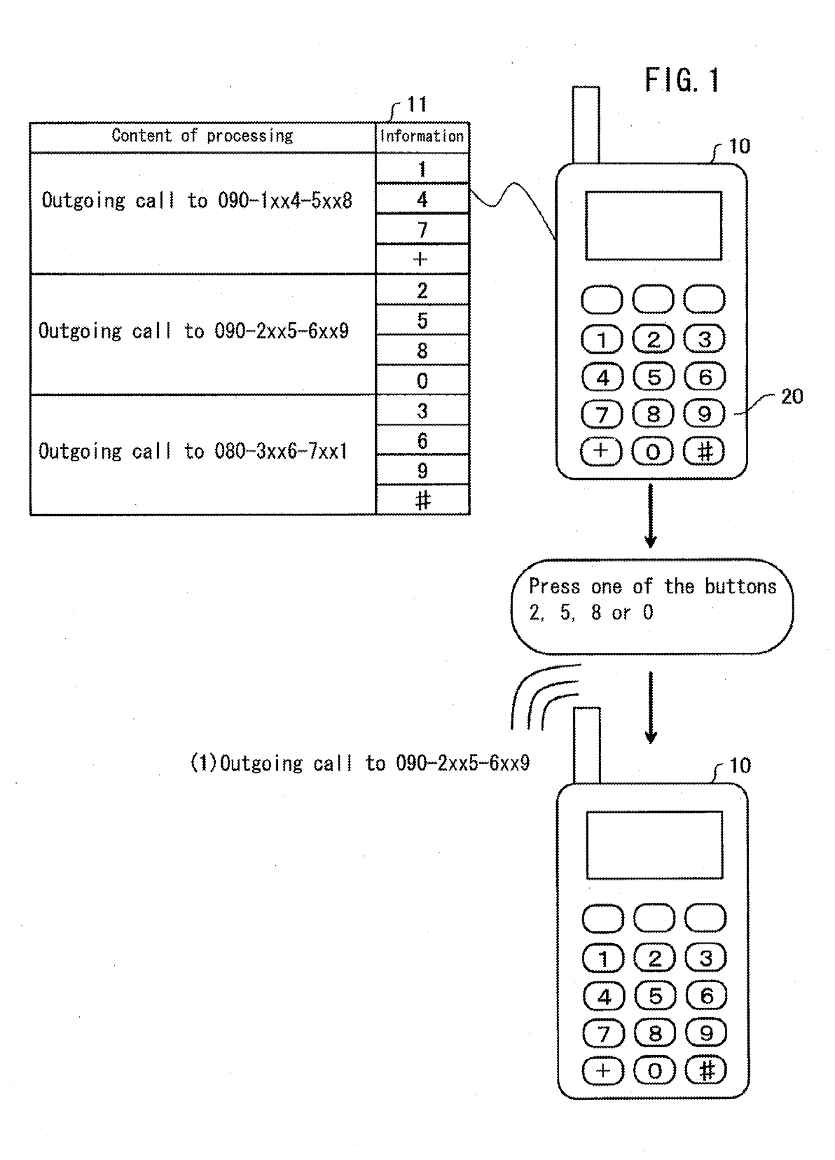

Utilizing FIG. 1, the overview and feature of the mobile terminal device that relates to the first embodiment are explained.

The overview of the mobile terminal device that relates to the first embodiment is explained as follows. A mobile terminal device 10 includes an input key comprising a plurality of areas. For example, the mobile terminal device 10 includes an input key 20 where a plurality of buttons are regularly arranged as shown in FIG. 1. Signs such as “1” and “#” are written on the buttons, respectively. And, when direction is accepted from a user by means of pressing or touching in the input key of the mobile terminal device 10, the mobile terminal device 10 executes processing according to the directed area. For example, when a button written with a number is pressed, as shown in FIG. 1, the mobile terminal device 10 executes processing including processing of accepting this number as a part of the outgoing call number, and so forth.

The mobile terminal device 10 holds the correspondence relation of a plurality of the areas and the content of processing, so that the respective areas are corresponded to the same content of processing in each area group comprising a plurality of areas.

For example, as shown in FIG. 1, the mobile terminal device 10 stores table 11 showing the correspondence relation of the content of processing “Outgoing call to 090-1xx4-5xx8” and “Information based on the signal which is output from four buttons written with “1”, “4”, “7”, and “ [symbol] ”, respectively”. In table 11, the correspondence relation of the content of processing “Outgoing call to 090-2xx5-6xx9” and “Information based on the signal which is output from four buttons written with “2”, “5”, “8”, and “#”, respectively” is also stored. And, in table 11, the correspondence relation of the content of processing “Outgoing call to 090-3xx6-7xx1” and “Information based on the signal which is output from four buttons written with “3”, “6”, “9”, and “#”, respectively” is also stored.

The mobile terminal device 10 selects the content of processing that is corresponded to the area directed by a user according to the correspondence relation, and then executes the selected content of processing.

As shown in FIG. 1, when a button written with “5” of the mobile terminal device is pressed by a user, a signal is output from the button written with “5”. Since the information based on this signal is corresponded to the content of processing “Outgoing call to 090-2xx5-6xx9” in table 11, the mobile terminal 10 executes the content of processing as specified (See (1) of FIG. 1).

Since this content of processing is corresponded to the information based on the signal which is output from the buttons written with “2”, “8”, and “0” as well as “5”, the mobile terminal device 10 executes the same content of processing when one of these buttons is pressed.

When a button written with a predetermined number is pressed, the mobile terminal device 10 usually executes processing of accepting this number as a part of the outgoing call number. The mobile terminal device 10 has the speed dialing function that dials the phone number that has already been registered when the predetermined button is pressed. In the first embodiment, for example, the case where the above-described processing is executed by using the speed dialing function is explained.

Therefore, it is possible to improve the operability to a user in this mobile terminal device. For example, when a user directs one of a plurality of the areas belonging to the same area group, such as a plurality of buttons, the mobile terminal device 10 executes the intended processing. As a result, it is not necessary to look for the button corresponding to the intended processing from among a plurality of the buttons, and it is also not necessary to take aim only at one operating button to press.

### Configuration of Mobile Terminal Device that Relates to the First Embodiment

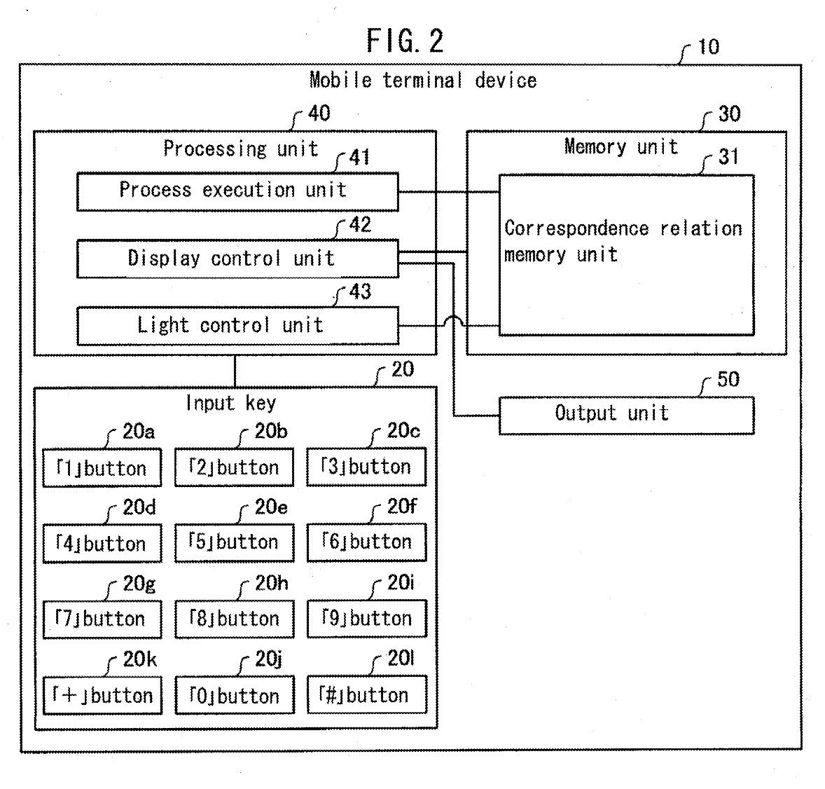

Utilizing FIG. 2, the configuration of the mobile terminal device that relates to the first embodiment shown in FIG. 1 is explained.

The mobile terminal device 10 includes the input key 20, a memory unit 30, a processing unit 40, and an output unit 50, as shown in FIG. 2.

The input key 20 accepts direction from a user by means of pressing or touching. Specifically, the input key 20 is provided with “1” button 20a-“0” 20j button, “ [symbol] ” button 20k and “#” button 20l. When each button is pressed, the input key 20 outputs a predetermined signal to the processing unit 40. For example, when the “1” button is pressed by a user, the input key 20 outputs a predetermined signal meaning “1” to the processing unit 40. Each button is provided with a LED (Light Emitting Diode) of three primary colors. By being controlled by a light control unit 43, LED emits light of the predetermined color. The input key 20 is provided with a button to control power on or power off in addition to these buttons.

The memory unit 30 has a correspondence relation memory unit 31 that stores the data and program required for various processing to be executed by the processing unit 40.

For each area group grouped into a plurality of areas where an area belongs to the same group as that of the adjacent area, the correspondence relation memory unit 31 stores the correspondence relation of a plurality of the areas and the content of processing, so that the respective areas are corresponded to the same content of processing in each area group. The correspondence relation memory unit 31 stores the correspondence relation of the content of processing that relates to the speed dialing function provided with the mobile terminal device 10, the information based on the signal which is output from each button provided with the input key 20, the button identification information used for the light control unit 43, as described below, to uniquely identify each button, and the light color information that indicates whether the button emits light.

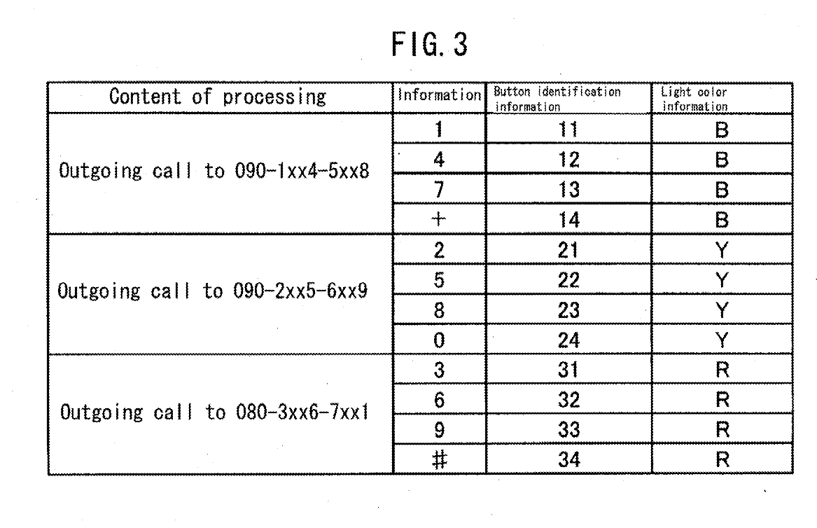

For example, as shown in FIG. 3, the correspondence relation memory unit 31 stores the information based on the correspondence relation of the signal which is output from the four buttons “1”, “4”, “7”, and “ [symbol] ” in response to the content of processing “Outgoing call to 090-1xx4-5xx8”. The correspondence relation memory unit 31 also stores the correspondence relation of the button identification information such as “11”, “12”, “13” and “14”, and the light color information such as “B” meaning Blue, in response to “Information” described above.

The processing unit 40 includes a process execution unit 41, a display control unit 42, and the light control unit 43. The processing unit 40 has a control program such as an OS (Operating System), a program that provides various processing procedures, and an internal memory used to store the required data. For example, the processing unit 40 executes processing of sending and receiving phone calls, sending and receiving mails, and browsing web page, and the like.

The process execution unit 41 selects the content of processing corresponding to the area directed by a user in accordance with the correspondence relation that is stored by the correspondence relation memory unit 31, and then executes the selected content of processing. Specifically, when accepting a signal which is output by the predetermined button in the input key 20 described above, the input key 41 converts the signal to the information that the signal has and selects the content of processing in accordance with the correspondence relation that is stored by the correspondence relation memory 31, and then executes the selected content of processing. For example, the process execution unit 41 accepts a signal which is output when a user presses the button “1”, then selects and executes the content of processing “Outgoing call to 090-1xx4-5xx8” in accordance with the correspondence relation that is stored by the correspondence relation memory unit 31.

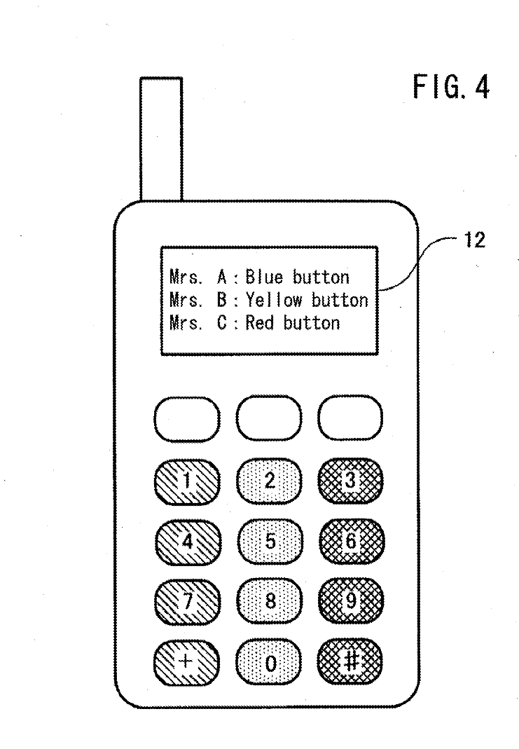

The display control unit 42 informs a user of the correspondence relation that is stored by the correspondence relation memory unit 31. Specifically, when the speed dialing function is started by the predetermined operation, the display control unit 42 reads the image information previously stored in the memory control unit 30, and then outputs it to the output unit 50. For example, as shown in FIG. 4, the display control unit 42 outputs the image information such as “Mrs. A Blue button” displayed on the display 12 to the output unit 50.

The light control unit 43 has the respective areas which are corresponded to the same content of processing in accordance with the correspondence relation that is stored by the correspondence relation memory unit 31 emit light of the same color. Specifically, when the speed dialing function is started by the predetermined operation, the light control unit 43 reads button identification information and light color information stored by the correspondence relation memory unit 31 from the correspondence relation memory unit 31, and then controls the LED of each button. For example, the light control unit 43 reads the button identification information “11” and the light color information “B” from the correspondence relation memory unit 31, and then controls the LED to make “1” button 20a indicated by the button information “11” emit blue light. In the correspondence relation memory unit 31, for each button group grouped in a way that the button and the adjacent button belong to the same button group, a plurality of the buttons are corresponded to the same content of processing. Therefore, the respective buttons are corresponded to the same content of processing in each button group. Consequently, as shown in FIG. 4, the light control unit 43 has each button emit light of the same color in each line.

The output unit 50 is comprised of a display. For example, the output unit 50 outputs various results of processing such as a display of the characters of “conversation” or the like by processing making/receiving calls executed by the processing unit 40. As shown in FIG. 4, when accepting screen information from the display control unit 42, the output unit 50 outputs the predetermined screen on the display.

### Processing by Mobile Terminal Device that Relates to the First Embodiment

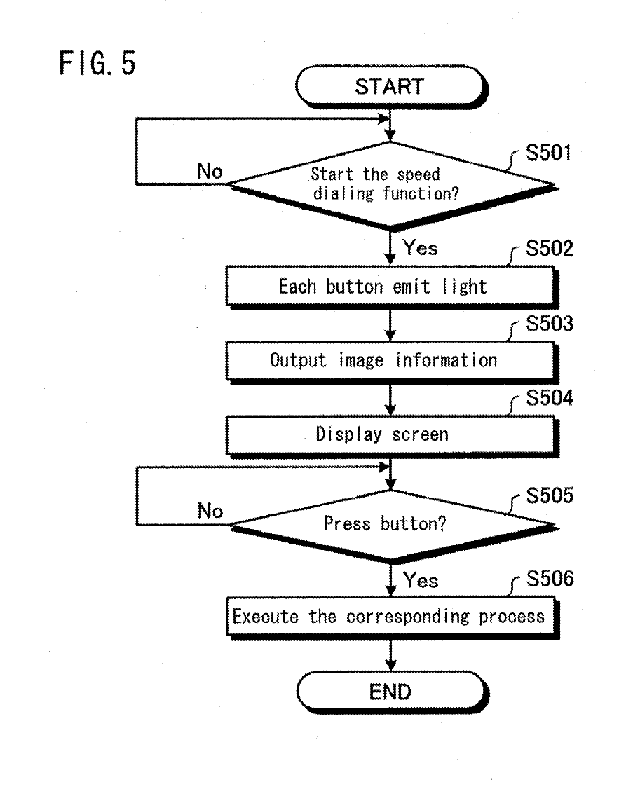

Utilizing FIG. 5, processing by the mobile terminal device in the first embodiment is explained.

When the speed dialing function is started by the predetermined operation (step S502), the light control unit 43 makes each button emit light (step S501 YES). The display control unit 42 outputs the image information which is previously stored in the memory unit 30 (step S503) to the output unit 50. The output unit 50 displays the predetermined screen on the display (step S504).

The mobile terminal device 10 oversees whether each button in the input key 20 is pressed (step S505). When the predetermined button in the input key 20 is pressed (step S505 YES), the process execution unit 41 executes processing corresponding to the pressed button (step S506).

### Effect of the First Embodiment

As described above, according to the first embodiment, the mobile terminal device stores the correspondence relation of a plurality of the buttons and the content of processing so that the respective buttons are corresponded to the same processing in each button group comprising a plurality of buttons. And the mobile terminal device selects the content of processing corresponding to the button which is pressed by a user, and then executes the selected content of processing, therefore, it is possible to improve the operability to a user. In other words, according to the first embodiment, when a user directs one of a plurality of the buttons belonging to the same button group, the intended processing is executed. Therefore, for example, it is not necessary to look for the button corresponding to the intended processing among from a plurality of the buttons. According to the first embodiment, it is possible to improve the operability to a user because it is not necessary to take aim only at one button to press.

According to the first embodiment, the mobile terminal device holds the correspondence relation that is prescribed for each condition which is assumed in advance, and selects the content of processing for the button which is pressed by a user in accordance with the correspondence relation, and then executes the selected content of processing. Therefore, it is possible to improve executing speed, comparing to the method for assigning the buttons dynamically depending on the number of content.

According to the first embodiment, it is possible to further improve the operability to a user because a user is informed of the correspondence relation by displaying the predetermined screen on the display.

According to the first embodiment, it is possible to further improve the operability to a user because the same content of processing makes each button emit light of the same color in the input key, so that a user can intuitively grasp a plurality of the buttons belonging to the same button group.

According to the first embodiment, the mobile terminal device holds the correspondence relation of a plurality of the buttons and the content of processing so that the respective buttons are corresponded to the same processing in each button group where the button and the adjacent button belong to the same button group. Therefore, it is possible to further improve the operability to a user. In other words, it is possible to provide a pseudo-large button where a plurality of the buttons belonging to the same button group become one pseudo-large button if the buttons are small. Therefore, it is possible to improve the operability to a user according to the first embodiment.

### The Second Embodiment

The first embodiment explained that the phone number that relates to the speed dialing function is registered in the mobile terminal device 10 in advance. The second embodiment explains that a new phone number that relates to the speed dialing function is registered in the mobile terminal device 10.

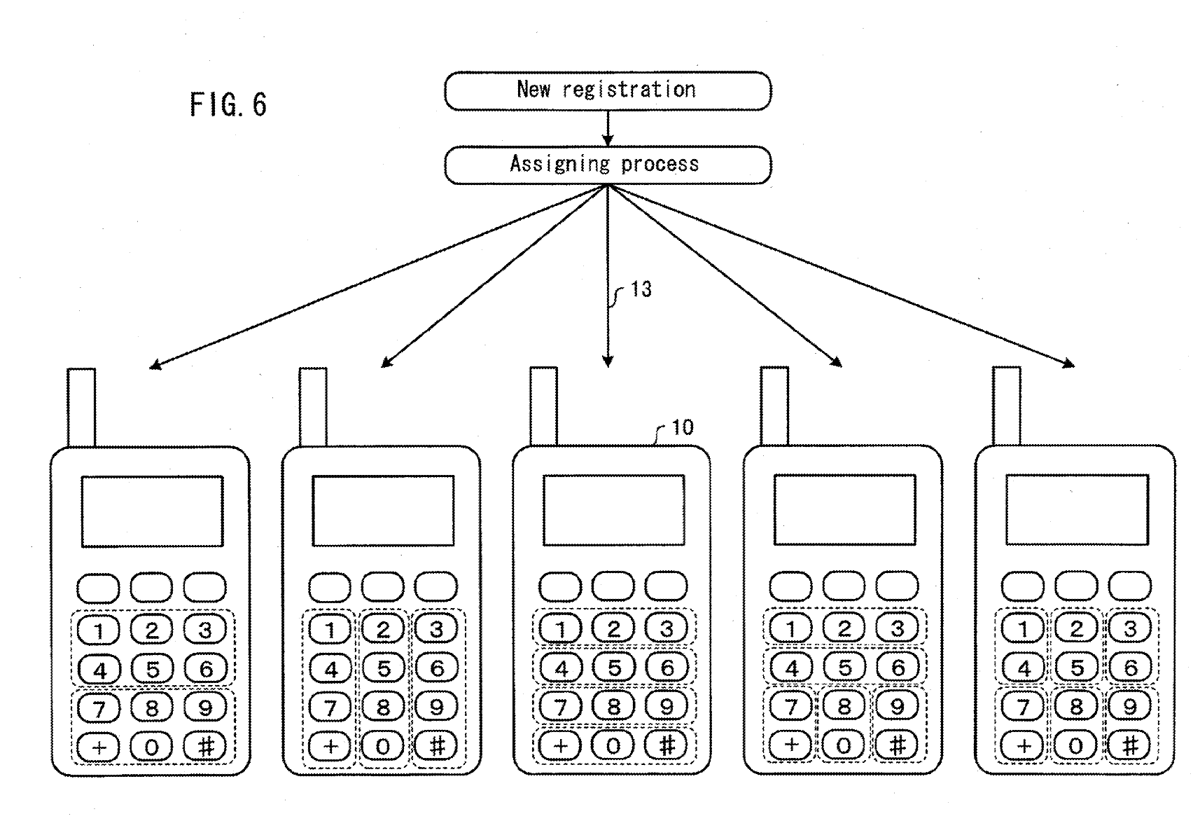

Utilizing FIG. 6, the mobile terminal device that relates to the second embodiment is explained.

When a new phone number is registered in the mobile terminal device 10, the input key 20 is grouped in a way that the respective buttons provided with the input key 20 are grouped into the same button group, depending on the number of content of processing that relates to the speed dialing function which is currently selectable to a user. The mobile terminal device 10 assigns the content of processing to each button, so that the respective buttons are corresponded to the content of the same processing in each button group.

For example, as shown in FIG. 6, when a new phone number that relates to the speed dialing function is registered, if four contents of processing including the content of processing for making a call to the corresponding phone number are selectable, the mobile terminal device 10 groups the buttons written with “1”, “2”, and “3” into one button group. The mobile terminal device 10 groups the buttons written with “4”, “5”, and “6” into one button group. The mobile terminal device 10 groups the buttons written with “7”, “8”, and “9” into one button group. The mobile terminal device 10 groups the buttons written with “ [symbol] ”, “0”, and “#” into one button group. Each button group is assigned in this way in accordance with the content of processing that relates to the speed dialing function. As shown in FIG. 6, even when the number of the selectable content of processing is two, three, five or six, the mobile terminal device groups the buttons provided with the input key in a way that the respective buttons are grouped evenly and also grouped into the same button group to be corresponded to the same content of processing in each button group.

### Configuration of Mobile Terminal Device that Relates to the Second Embodiment

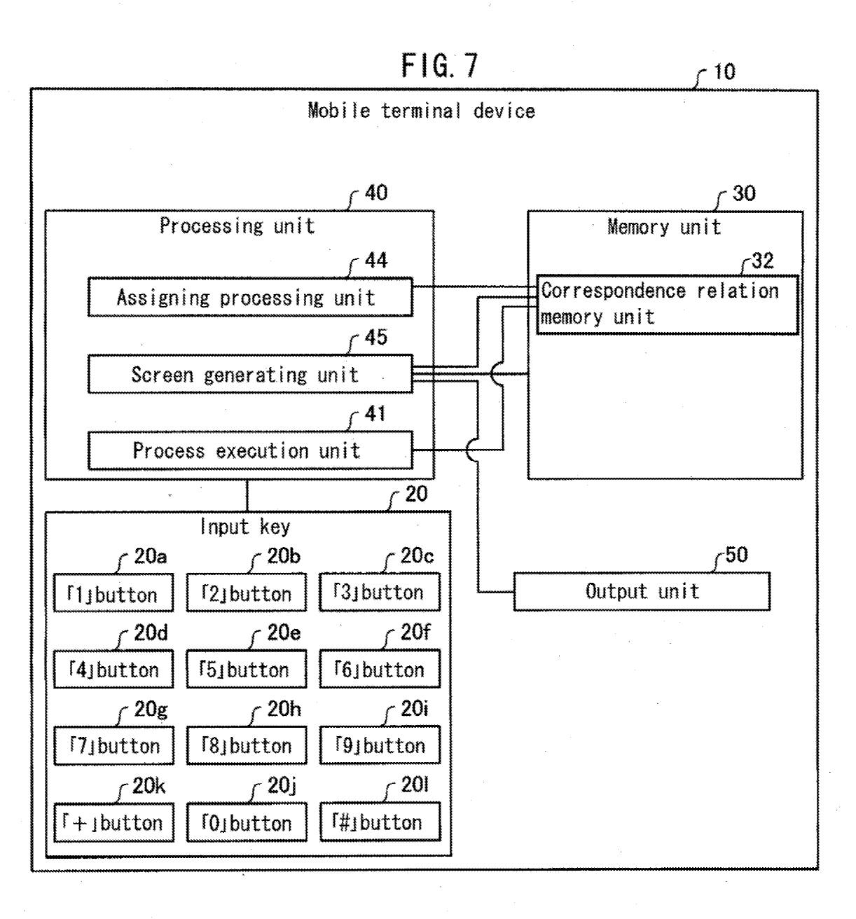

Utilizing FIG. 7, the configuration that relates to the second embodiment as shown in FIG. 6 is explained.

As shown in FIG. 7, the mobile terminal device 10 includes the input key 20, the memory unit 30, the processing unit 40 and the output unit 50. The input key 20 includes “1” button 20a-“0” button 20j, “ [symbol] ” button 20k, and “#” button 20l. The memory unit 30 includes a correspondence relation memory unit 32. The processing unit 40 includes the process execution unit 41, an assigning processing unit 44 and a screen generation unit 45. In the second embodiment, if there is the same explanation regarding the units as in the first embodiment, the same description is omitted by adding the number of the unit. The second embodiment only explains the correspondence relation memory unit 32, the assigning process unit 44 and the screen generating unit 45.

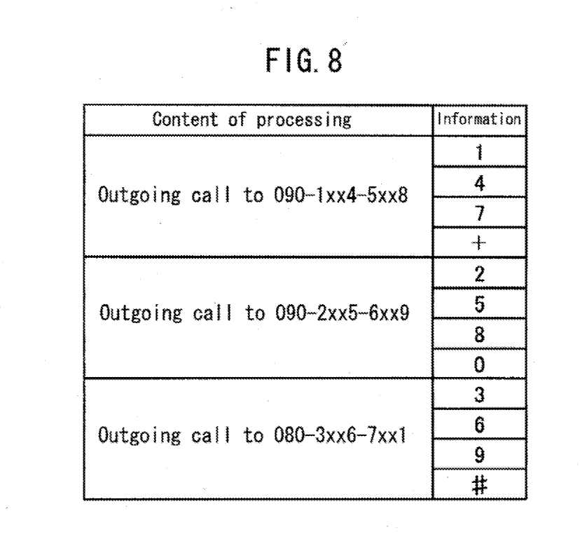

For the respective area groups which are grouped in a way that the adjacent areas belong to the same area group, the correspondence relation memory unit 32 stores the correspondence relation of a plurality of the areas and the contents of processing so that the respective areas are corresponded to the same content of processing in each area group. Specifically, as shown in FIG. 8, the correspondence relation memory unit accepts and stores the correspondence relation of the content of processing that relates to the speed dialing function which is output from the assigning processing unit 44 and the information based on the signal which is output from each button group.

For example, as shown in FIG. 8, the correspondence relation memory unit 32 accepts and stores the correspondence of “Information based on the signal which is output from four buttons written with “1”, “4”, “7”, and “ [symbol] ”, respectively” in response to the content of processing “Outgoing call to 090-1xx4-5xx8”, from the processing unit 44.

The assigning processing unit 44 groups a plurality of the areas depending on the number of content of processing which is currently selectable to a user, and assigns the content of processing to each area, so that the respective areas are corresponded to the same content of processing in each area group.

The assigning processing unit 44 determines the grouping in a way that the respective buttons of the input key 20 are evenly grouped into button groups and also the adjacent buttons are grouped into the same button group. Based on the determined grouping, the assigning processing unit 44 stores the correspondence relation of the information that relates to the speed dialing function and the information based on the signal which is output from each button group into the correspondence relation memory unit 32. For a predetermined operation of registering the phone number that relates to the speed dialing function in the mobile terminal device 10, a user is allowed to determine whether or not to register the phone number as the phone number that relates to the speed dialing function after a phone number and a name etc., are registered in a phone-directory.

When a new phone number that relates to the speed dialing function is registered, in case of four contents of processing which are currently selectable to a user, the assigning processing unit 44 determines the grouping in a way that twelve buttons in the input key are grouped into four button groups where each button group is consisted of three buttons. The assigning processing unit 44 stores the correspondence relation of the four contents of processing that relates to the speed dialing function to the information based on the signal which is output from “1” button 20a-“3” button 20c, to the information based on the signal which is output from “4” button 20d-“6” button 20f, to the information based on the signal which is output from “7” button 20g-“9” button 20i, and to the information based on the signal which is output from “0” button 20j-“#” button 20l, respectively.

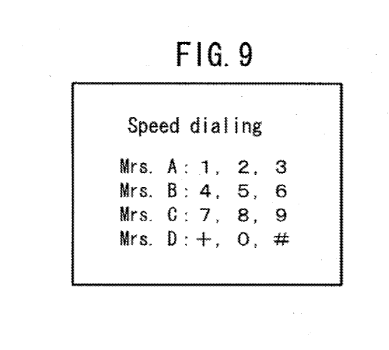

The screen generation unit 45 informs a user of the correspondence relation that is stored by the correspondence relation memory unit 32. Specifically, when the speed dialing function is started by the predetermined operation, the screen generation unit 45 generates a predetermined image information based on the correspondence relation stored by the correspondence relation memory unit 32 or various data stored by the memory unit 30, and then outputs the generated image information to the output unit 50. For example, the screen generating unit 45 generates a image information comprising the character string of “Mrs. A→1, 2, and 3” in accordance with the correspondence relation of the content of processing “Outgoing call to 090-1xx4-5xx8” and the information based on the signal which is output from “1” button 20a-“3” button 20c. As shown in FIG. 9, the output unit 50 outputs the predetermined screen to the display in accordance with the image information which is accepted from the screen generating unit 45.

### Processing by Portable Terminal Device that Relates to the Second Embodiment

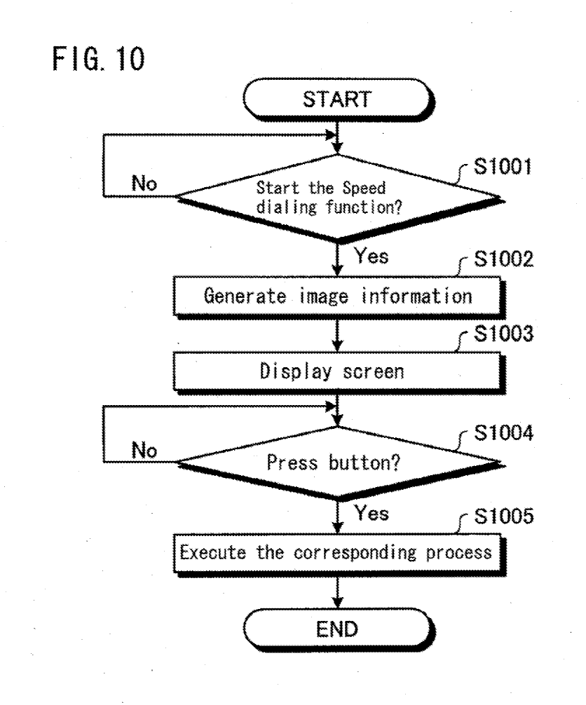

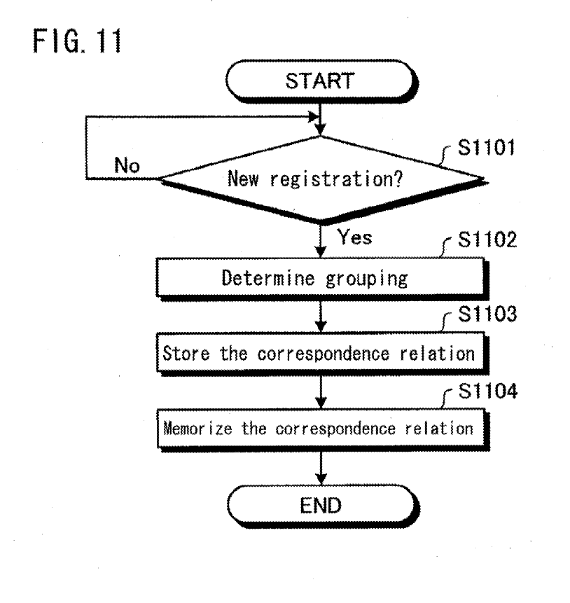

Utilizing FIG. 10 and FIG. 11, processing by the mobile terminal device in the second embodiment is explained.

As shown in FIG. 10, when the speed dialing function is started by the predetermined operation (step S1001 YES), the screen generating unit 45 generates the predetermined image information (step S1002). The output unit 50 outputs the predetermined screen based on the image information (step S1003).

The mobile terminal device 10 oversees whether each button in the input key 20 is pressed (step S1004). When the predetermined button is pressed (step S1004 YES), the process execution unit 41 executes the content of processing corresponding to the information based on the signal which is output from the pressed button (step S1005).

As shown in FIG. 11, when the telephone number that relates to the speed dialing function by the predetermined operation in the mobile terminal device 10 (step S1101 YES), the assigning processing unit 44 determine the grouping in a way that the buttons in the input key 20 are evenly grouped and also the adjacent buttons are grouped into the same button group, depending on the number of content of processing that relates to the speed dialing function which is currently selectable to a user (step S1102). Based on the grouping, the assigning processing unit 44 stores the correspondence relation of the content of processing that relates to the speed dialing function and the information based on the signal which is output from each button provided with the input key 20 (step S1103). The correspondence relation memory unit 32 stores the correspondence relation of the content of processing that relates to the speed dialing function and the information based on the signal which is output from each button provided with the input key 20 (step S1104).

### Effect of the Second Embodiment

In the second embodiment, the buttons are grouped depending on the number of content of processing which is selectable to a user, and the content of processing is assigned to each button so that the respective buttons are corresponded to the same content of processing in each button group. According to the second embodiment, therefore, it is possible to improve the operability to a user even when the number of the content of processing which is selectable to a user varies.

### Other Embodiment

There may be other embodiments in various ways in addition to the embodiment described above. Other embodiments are explained in (1)-(8) respectively, as follows.

(1) Form of Input Key

In the first embodiment described above, the case where the input key is comprised of a plurality of buttons and it accepts direction to the buttons from a user by means of pressing or touching is disclosed. The embodiment is not limited to what has been described above. An input key in any form is applicable if it is comprised of a plurality of areas. In another embodiment, for example, an input key is comprised of a touch panel and is able to accept user's direction by means of pressing or touching a touch panel. In still another embodiment, a plurality of keys are arranged in an input key and user's direction can be accepted by means of pressing those keys.

(2) Button Group

In the first embodiment described above, a button group in the correspondence to the same content of processing is explained as a button group which is comprised of the adjacent buttons. The embodiment is not limited to what has been described. In another embodiment, a button group can be comprised of buttons that are not adjacent. In still another embodiments as well, it is not necessary to look for one button corresponding to the intended processing from among a plurality of the buttons. In the additional embodiments, it is possible to improve the operability to a user because it is not necessary not to take aim only at one button to press.

(3) Inform Correspondence Relation

In the first embodiment described above, the case where the correspondence relation of the button and the content of processing are displayed on the display of the mobile terminal device is explained. The embodiment is not limited to what has been described above. The mobile terminal device does not necessarily provide a method for informing a user of the correspondence of the button and the content of processing.

(4) Lighting Button

In the first embodiment described above, the case where the buttons that are corresponded to the same content of processing emit light of the same color is explained. The embodiment is not limited to what has been described. The mobile terminal device does not necessarily provide a method to make the buttons emit light in accordance with the regulation as described above.

In the second embodiment described above, it is explained that the buttons do not emit light. The embodiment is not limited to what has been described above. The buttons in the correspondence with the same content of processing may emit light of the same color as well as in the first embodiment. Specifically, the mobile terminal device 10 is also provided with a LED for each button and a light control method in the processing unit 40. The assigning processing unit 44 corresponds to the information based on the signal which is output from each button group to the content of processing that relates to the speed dialing function. The assigning processing unit 44 corresponds to the information based on the signal which is output from each button group to the content of processing that relates to the speed dialing function, and then stores the correspondence of the identification information of the button to the light color information according to the determined grouping in the correspondence relation memory unit 32. By using the light control method, the LED of each button is controlled in accordance with the correspondence relation to make each button emit light.

(5) User Direction

In the first embodiment described above, it is explained that a direction is accepted from a user by means of pressing or touching with a user's finger. The embodiment is not limited to what has been described. Any method is applicable if it accepts direction from a user in terms of results. In another embodiment, for example, user's direction can be accepted by means of pressing or touching with a pen-like stick to operate the input key.

(6) Grouping Determination

In the second embodiment, the case where the respective buttons in the input key 20 are grouped in a way that the buttons are grouped evenly into button groups depending on the number of contents of processing that relates to the speed dialing function which is currently selectable to a user is explained. The embodiment is not limited to what has been described above. The buttons are grouped in a way that the more the frequency of execution increases, the more buttons are assigned, according to the frequency of execution in each of the content of processing which is currently selectable to a user.

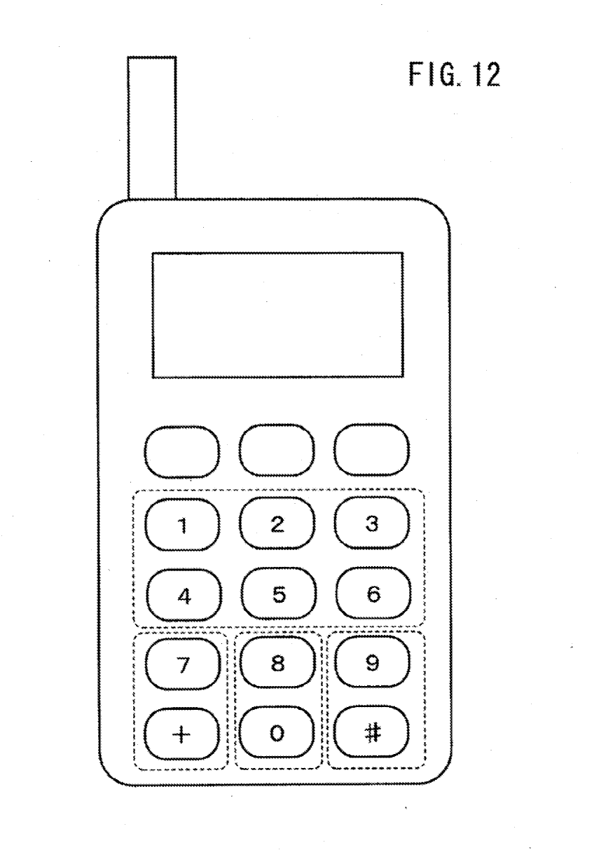

For example, as shown in FIG. 12, when a new phone number that relates to the speed dialing function is registered in the mobile terminal device, in case of four content of processing that relate to the speed dialing function which is selectable to a user, the assigning processing unit 42 can determine the grouping in a way that the twelve buttons in the input key 20 are grouped into one button group comprising of six button and three button groups comprising two buttons for each group.

The content of processing is assigned to each button in a way that the more the frequency of execution increases, the more buttons are assigned to, according to the frequency of execution in each of the contents of processing which is currently selectable to a user, therefore, it is possible to improve the operability to a user in this embodiment. For example, the higher the frequency of execution is, the easier a user press the buttons where many buttons are assigned to the content of processing. Therefore, it is possible to further improve the operability to a user. Instead of the grouping in a way that the buttons are grouped depending on the weight of the frequency of execution of the content of processing, a grouping can be determined in a way that the more current the time of executing the content of processing is to the present moment, the more buttons the content of processing is assigned to.

(7) Informing Correspondence Relation

In the second embodiment described above, the case where a user is informed of the correspondence relation by means of outputting to be displayed a sign written on a button or a name of a party in the output unit 50 is explained. The embodiment is not limited to what has been described above. Any method for informing a user of the correspondence relation is applicable. In another embodiment, for example, a user can be informed of the correspondence relation by means of speech through a speaker. In still another embodiment, the correspondence relation can be displayed directly on a panel of the input unit provided with a touch panel.

(8) Content of Processing

In the first embodiment described above, the case where the content of processing is executed with the speed dialing function specific to the mobile terminal device is explained. The embodiment is not limited to what has been described above. Any content of processing that accepts direction from a user by means of pressing or touching in the input unit comprising a plurality of areas is applicable. For example, another embodiment can be applied to the content of processing that displays a plurality of possible characters by using letter conversion, and then waits for user's choice when a name corresponding to the phone number is accepted in the phone-directory.

(9) The mobile terminal device in the present embodiment may be comprised of a plurality of operating units, processing units and assigning units. The content of processing is assigned to a plurality of the operating units. When one of a plurality of the operating units is operated, the processing unit executes processing corresponding to the operating unit. The assigning unit divides the operating units into a plurality of areas, and determines each area to be corresponded to the content of processing, respectively.

Specifically, for example, when there are buttons in four rows and three columns, the assigning unit groups these buttons into one area for each line, and determines the correspondence relation of each line and the content of processing corresponding to the line. Having the correspondence relation of a plurality of the buttons and the contents that is determined by the assigning unit, the processing unit can execute processing corresponding to the button when one of a plurality of the buttons is pressed.

(10) The mobile terminal device may be comprised of the control unit that displays the relation visually distinguished according to the corresponded content of processing.

Specifically, for example, the control unit may provide the buttons that are visually distinguished according to the corresponded content of processing for the buttons in four rows and three columns as described above, such as red light for buttons in the first row, green light for buttons in the second row, blue light for buttons in the third row, and yellow light for buttons in the forth row.

(11) The mobile terminal device in the present embodiment may be comprised of a plurality of operating units, processing units and assigning units. The content of processing is assigned to a plurality of the operating units. When one of a plurality of the operating units is operated, the processing unit executes the processing corresponding to the operating unit. The assigning unit determines the number of the operating unit which is to be corresponded to each of the contents of processing depending on the number of contents of processing that is to be a choice. Specifically, for example, when there are buttons arranged in four rows and three lines and there are four contents of processing as choices, the assigning unit determines the correspondence relation in a way that, out of twelve buttons in total, one content of processing is corresponded to two buttons, one content of processing is corresponded to three buttons, one content of processing is corresponded to four buttons and one content of processing is corresponded to three buttons. Having the correspondence relation of a plurality of the buttons and the contents that is determined by the assigning unit, the processing unit may execute processing corresponding to the button when one of a plurality of the buttons is pressed.

(12) The assigning unit may have the correspondence relation of the respective contents of processing and a plurality of the operating units in a way that the number of the operating unit is evenly assigned to the respective contents of processing.

Specifically, for example, the assigning unit may determine the correspondence relation in a way that four contents of processing are corresponded to three buttons evenly, of twelve buttons in total as described above.

(13) The mobile terminal device in the present embodiment may be comprised of a plurality of operating units, processing units and assigning units. The content of processing is corresponded to a plurality of the operating units. When one of a plurality of the operating units is operated, the processing unit executes processing corresponding to the operating unit. When there is a plurality of contents of processing as choices, the assigning unit divides the operating units into a plurality of areas and determines the area that is to be corresponded to the respective contents of processing.

Specifically, for example, when there are buttons arranged in four rows and three lines and there are four contents of processing as choices, the assigning unit determines the correspondence relation in a way that buttons are divided into one area for each row, and each row is corresponded to the content of processing. Having the correspondence relation of a plurality of the buttons and the contents of processing that is determined by the assigning unit, the processing unit may execute processing corresponding to the button when one of a plurality of the buttons is pressed.

As described above, the memory medium in which the process execution program is stored, and the process execution device and the method for executing that relates to the present embodiment apply to the case where direction is accepted from a user by means of pressing or touching in the input key comprising a plurality of buttons, processing is executed in accordance with the directed buttons. In particular, this is applicable to improve the operability to a user.

Although the invention has been described with respect to a specific embodiment for a complete and clear disclosure, the appended claims are not to be thus limited but are to be construed as embodying all modifications and alternative constructions that may occur to one skilled in the art that fall within basic teaching herein set forth.

What is claimed is:

1. A computer-readable recording medium having stored therein a computer program that causes a computer to implement a method for executing processing depending on areas directed by a user by means of pressing or touching in an input key comprising a plurality of areas, the computer program causing the computer to execute:
storing a correspondence relation of a plurality of the areas and a content of processing that the respective areas are corresponded to the same content of processing in each area group comprising said plurality of areas; and
executing a selected content of processing which corresponds to a directed area by said user in accordance with the stored correspondence relation.

2. The computer-readable recording medium according to claim 1, further comprising:
informing the correspondence relation to the user.

3. The computer-readable recording medium according to claim 1, wherein
the storing includes storing the correspondence relation that is predetermined for respective conditions assumed in advance; and
the executing a selected content of processing which is corresponded to the directed area by the user in accordance with the correspondence relation to the current condition in the stored correspondence relation.

4. The computer-readable recording medium according to claim 1, further comprising:
grouping the plurality of the areas into area groups depending on number of contents of processing which is currently selectable to the user; and
assigning the content of processing to each of the plurality of the areas, so that the respective areas are corresponded to the same content of processing,
wherein the storing includes storing the assigned correspondence relation.

5. The computer-readable recording medium according to claim 4, wherein
the assigning includes assigning a plurality of the areas wherein as frequency of execution increases, more areas are assigned, according to the frequency of execution in each of the contents of processing which is currently selectable to the user.

6. The computer-readable recording medium according to claim 1, further comprising:
lighting light of the same color in the input key for the respective areas which are corresponded to the same content of processing in accordance with the stored correspondence relation.

7. The computer-readable recording medium according to claim 1, wherein
the storing includes storing the correspondence relation of a plurality of the areas and the content of processing, so that the respective areas are corresponded to the same content of processing in each area group, for each area group comprising a plurality of areas where the adjacent areas belong to the same area group.

8. A process execution device that accepts direction from a user by means of pressing or touching an input key with a plurality of areas and executes processing depending on directed areas, the process execution device comprising:
a memory unit that stores correspondence relation of the plurality of the areas and content of processing that respective areas are corresponded to the same content of processing in each area group comprising the plurality of areas; and
a process execution unit that executes a selected content of processing and selects the content of processing corresponding to the areas directed by the user in accordance with the correspondence relation which is stored by said memory unit.

9. The process execution device according to claim 8, further comprising:
an assigning unit that groups the input key into a plurality of areas depending on the number of contents of processing and that determines the areas to be corresponded to the respective contents of processing.

10. The process execution device according to claim 8, further comprising:
a control unit that controls display of the input key to be visually distinguished according to the content of processing of the correspondence relation.

11. The process execution device according to claim 8, further comprising:
an assigning unit that determines the number of input keys that correspond to the respective contents of processing depending on the number of contents of processing.

12. The process execution device according to claim 11, wherein:
the assigning unit has the correspondence relation of the respective contents of processing and a plurality of input keys wherein the number of the input keys are evenly assigned to the respective contents of processing.

13. The process execution device according to claim 8, further comprising:
an assigning unit that divides the input key into a plurality of areas when there are a plurality of contents of processing and that determines the areas to be corresponded to the respective contents of processing.

14. A method of process executing that accepts direction from a user by means of pressing or touching in an input key comprising a plurality of areas and executes depending on the directed areas, the method comprising:
storing a correspondence relation of the plurality of areas and content of processing that the areas are corresponded to the same content of processing in each area group; and
executing a selected content of processing which corresponds to the directed area by a user in accordance with the stored correspondence relation.
